(19) United States
(12) Patent Application Publication
(10) Pub. No.: US 2011/0156959 A1
(43) Pub. Date: Jun. 30, 2011

(54) Flexible Printed Antenna

(75) Inventors: Tsung-Wen Chiu, Taipei (TW); Fu Ren Hsiao, Taipei (TW)

(73) Assignee: ADVANCED CONNECTEK INC., Taipei County (TW)

(21) Appl. No.: 12/773,600

(22) Filed: May 4, 2010

(30) Foreign Application Priority Data
Dec. 25, 2009 (TW) 098144904

(51) Int. Cl. H01Q 9/04

(52) U.S. Cl. 343/700 MS

(57) ABSTRACT

A flexible printed antenna comprises a flexible substrate, a radiation conductor, a flexible feeder cable and a grounding member. The radiation conductor includes a primary conductor and at least one secondary conductor. The flexible substrate is interposed between the primary conductor and the secondary conductor. One end of the feeder cable connects with the primary conductor, and another end extends far away from the primary conductor and connects with the signal source. The present invention is characterized in adopting a flexible substrate made of a FPCB material and forming a radiation conductor and a flexible feeder cable on different surface of the flexible substrate. Thereby, the antenna module of the present invention has better flexibility and applies to various non-planar structures of various communication products. Further, the present invention can be fabricated into a multi-layer antenna structure to greatly reduce the thickness of the antenna.

### BACKGROUND OF THE INVENTION

1. Field of the Invention

The present invention relates to a flexible printed antenna, particularly to a flexible multi-layer antenna structure.

2. Description of the Related Art

The wireless communication technology is developing rapidly, and the tendency of antenna design is to meet the miniaturization and multiband requirements of the communication devices. Thus, different types of antennae are integrated into a single antenna module to satisfy the strict design standard of antennae.

Refer to FIG. 1 a diagram schematically a conventional integrated antenna for a dual-network communication device. The integrated antenna comprises a grounding plane 13, a first antenna 14, a second antenna 15, a first coaxial feeder cable 16 and a second coaxial feeder cable 17. The rectangular grounding plane 13 has a first grounding point 132 and a second grounding point 133. The first antenna 14 is arranged near the top edge 131 of the grounding plane 13 to implement the operation of a first wireless network. The second antenna 15 is also arranged near the top edge 131 of the grounding plane 13 to implement the operation of a second wireless network. The abovementioned antenna design can realize the dual-network function of a mobile phone system or a WLAN (Wireless Local Area Network) system.

The first and second coaxial feeder cables 16 and 17 have to be embedded in the system to respectively implement the operations of the first and second antennae 14 and 15. When signals are simultaneously transmitted in the feeder cables, they are likely to interfere with each other. Further, the feeder cables are very long, which increases the difficulties in embedding and wiring the feeder cables and prolongs the fabrication time of the antenna.

### SUMMARY OF THE INVENTION

One objective of the present invention is to provide a flexible printed antenna, wherein a flexible substrate of the antenna adopts a FPCB (Flexible Printed Circuit Board) material, and wherein a radiation conductor and a feeder cable are directly formed on the surface of the flexible substrate, whereby the antenna module has a better flexibility and applies to the curved structures of various communication products.

Another objective of the present invention is to provide a flexible printed antenna, wherein a flexible printed circuit board, a printed radiation conductor and a printed flexible feeder cable are integrated into a thin antenna module, whereby is formed a multi-layer antenna structure, greatly reduced the thickness of the antenna, and increased the convenience of assembling the antenna module.

A further objective of the present invention is to provide a flexible printed antenna, wherein the feeder cable is integrated with the antenna, whereby the feeder cable does not occupy additional space, and whereby the radiation area of the antenna is greatly increased, and whereby the performance and radiation efficiency of the antenna is greatly promoted.

A further another objective of the present invention is to provide a flexible printed antenna, wherein the flexible feeder cable is directly printed on a flexible substrate without soldering and wiring, whereby the antenna module is easy to bend, and whereby the fabrication time and cost is effectively reduced.

To achieve the abovementioned objectives, the present invention proposes a flexible printed antenna, which comprises a flexible substrate, a radiation conductor, a flexible feeder cable, and a grounding member. The radiation conductor includes a primary conductor and at least one secondary conductor. The flexible substrate adopts a FPCB material. The primary conductor and the secondary conductor are respectively formed on different surfaces of the flexible substrate, and the flexible substrate is interposed between the primary conductor and the secondary conductor. The flexible feeder cable is printed on the surface where the primary conductor is formed. One end of the flexible feeder cable is connected to the primary conductor, and another end of the flexible feeder cable is connected to a signal source.

In a first embodiment of the present invention, the flexible substrate adopts a FPCB material and cooperates with the primary conductor, secondary conductor and flexible feeder cable to form a super-thin antenna module, wherein the flexible feeder cable is integrated with the antenna structure, whereby is greatly reduced the whole thickness of the antenna, and whereby are increased the radiation area, performance and radiation efficiency of the antenna, wherefore is expanded the application field of the antenna. As the elements of the antenna module are all made of flexible materials, the entire antenna module has superior flexibility. Thus, the present invention applies to the non-planar structures of various communication products. Besides, the flexible feeder cable is directly printed on the surface of the flexible substrate without the wiring and soldering processes that are required in the conventional technology. Therefore, the present invention can effectively reduce the time and cost of fabrication.

A third embodiment and a fourth embodiment are basically similar to the first embodiment in that one end of the flexible feeder cable is connected to the primary conductor but different from the first embodiment in that a capacitor unit and an inductor unit extend from another end of the flexible feeder cable. The inductor unit and the capacitor unit may be connected in parallel or in series. The inductor unit is designed to have a serpentine form. The capacitor unit is formed of a first coupling unit and a second coupling unit, which are arranged opposite to each other.

Below, the embodiments are described in detail to make easily understood the technical contents of the present invention.

### BRIEF DESCRIPTION OF THE DRAWINGS

FIG. 1 is a diagram schematically a conventional integrated antenna for a dual-network communication device;

FIG. 2 is a perspective assembly drawing of a flexible printed antenna according to a first embodiment of the present invention;

FIG. 3 is a perspective exploded view schematically showing a flexible printed circuit according to a second embodiment of the present invention;

FIG. 4 is a top view of the flexible printed antenna according to the second embodiment of the present invention;

FIG. 5 is a sectional view of the flexible printed antenna along Line A-A in FIG. 4;

FIG. 6 is a perspective exploded view schematically showing a flexible printed circuit according to a third embodiment of the present invention; and

FIG. 7 is a perspective exploded view schematically showing a flexible printed circuit according to a fourth embodiment of the present invention.

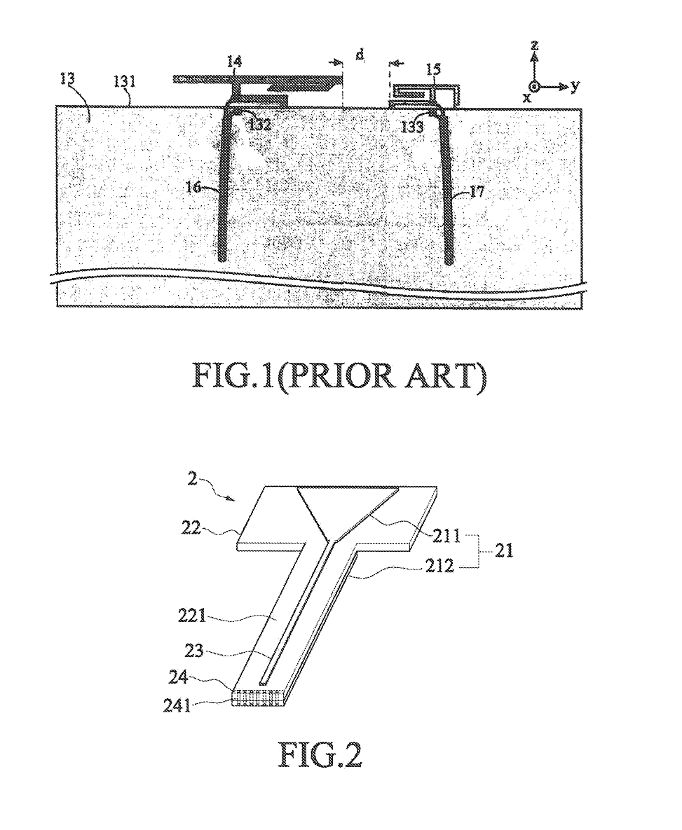

### DETAILED DESCRIPTION OF THE INVENTION

Refer to FIG. 2 a perspective assembly drawing of a flexible printed antenna according to a first embodiment of the present invention. The antenna module 2 of the present invention comprises a radiation conductor 21, a flexible substrate 22, a flexible feeder cable 23 and a grounding member 24. The radiation conductor 21 includes a primary conductor 211 and a secondary conductor 212. The grounding member 24 has a plurality of through-holes 241 reaching the secondary conductor 212 and used to conduct the electrical signals between the secondary conductor 212 and the grounding member 24.

The flexible substrate 22 adopts a FPCB material. The primary conductor 211 and the secondary conductor 212 are respectively printed on the upper surface 221 and the lower surface 222 (not shown in the drawing) with the flexible substrate 33 interposed between the primary conductor 211 and the secondary conductor 212 to form the main structure of the radiation conductor of the antenna. The flexible feeder cable 23 is printed on the upper surface 221 where the primary conductor 211 is printed. One end of the feeder cable 23 is connected to the primary conductor 211, and another end of the feeder cable 23 extends far away from the primary conductor 211 to connect with the feed-in signal source of the antenna. The grounding member 24 is also formed on the upper surface 221 where the primary conductor 211 is printed. The grounding member 24 is arranged on the upper surface 221 where the primary conductor 211 is printed and near the feeder cable 23 and the feed-in signal source. The signal source feeds the positive signal of the antenna to the flexible feeder cable 23, and the feed-in signal is then transmitted through the flexible feeder cable 23 to the primary conductor 211. The negative signal is transmitted from the signal source through the grounding member 24 and the through-holes 241 to the secondary conductor 212. The flexible cable 23 and the secondary conductor 212 jointly form the feeding-transmitting interface of the high-frequency signal of the antenna, whereby the antenna signal is transceived.

The primary conductor 211 has a trapezoid-like shape with a top base of about 24 mm, a bottom base of about 0.5 mm, a height of about 11 mm and two legs each of about 16 mm. The secondary conductor 212 has a length of about 40 mm, a width of about 10 mm and a thickness of about 0.1 mm. The flexible substrate 22 may be roughly divided into two rectangles. The rectangle supporting the primary conductor 211 has a length of about 32 mm, a width of about 12 mm and a thickness of about 0.3 mm. The rectangle supporting the secondary conductor 212 has a length of about 40 mm, a width of about 10 mm and a thickness of about 0.3 mm. The flexible feeder cable 23 has a length of about 37 mm and a width of about 0.33 mm. The grounding member 24 has a length of about 10 mm and a width of about 0.1 mm.

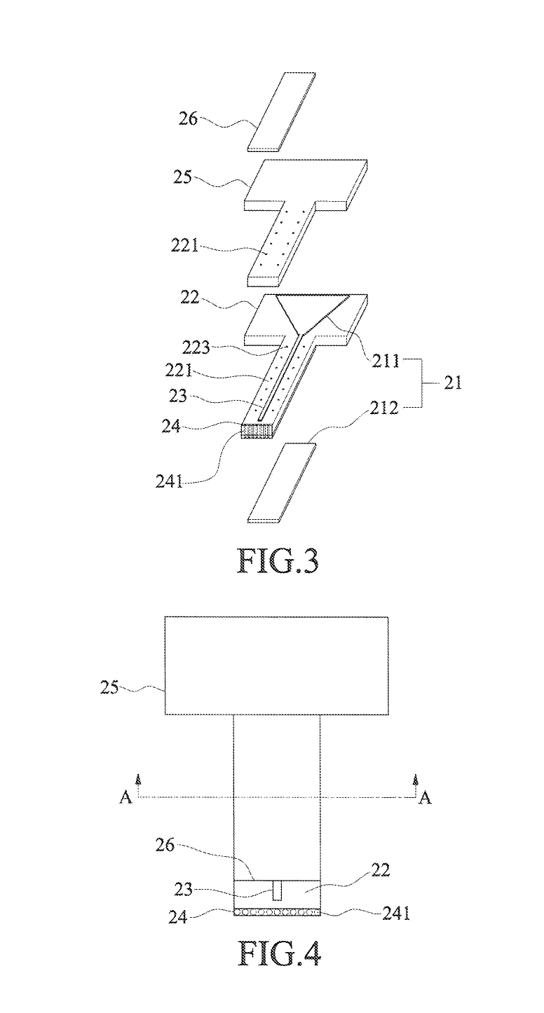

Refer to FIG. 3 a perspective exploded view schematically showing a flexible printed circuit according to a second embodiment of the present invention. The second embodiment is basically similar to the first embodiment except two sides of the flexible feeder cable 23 have conduction holes 223 reaching the secondary conductor 212 in the second embodiment. In the second embodiment, a first flexible substrate 25 is arranged on the upper surface 221 of the flexible substrate 22, and a first secondary conductor 26 is arranged on the upper surface of the first flexible substrate 25. The first flexible substrate 25 also has conduction holes 223 reaching the first secondary conductor 26 and corresponding to the conduction holes 223 on two sides of the flexible feeder cable 23. The first flexible substrate 25 and the first secondary conductor 26 contract from the signal source toward the primary conductor 211 lest the feeding of the positive signal of the antenna be retarded. The signal source feeds the positive signal of the antenna to the flexible feeder cable 23, and the feed-in signal is then transmitted through the flexible feeder cable 23 to the primary conductor 211. The negative signal is transmitted from the signal source through the grounding member 24 and the through-holes 241 to the secondary conductor 212. The negative signal is further transmitted through the conduction holes 223 of the flexible substrate 22 to the first secondary conductor 26. Thereby is transceived the antenna signal.

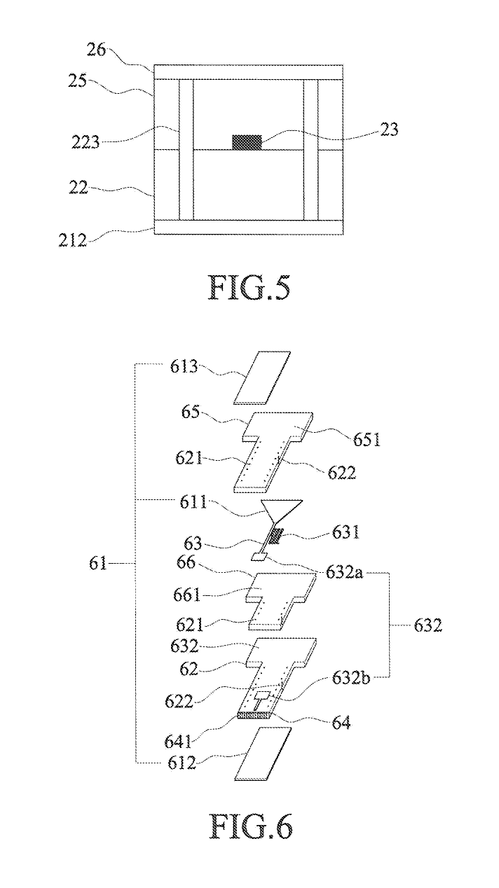

Refer to FIG. 4 and FIG. 5 a top view and a sectional view of the flexible printed antenna according to the second embodiment of the present invention. In the second embodiment, the first flexible substrate 25 and the first secondary conductor 26 contract from the signal source toward the primary conductor 211 to prevent from retarding the transmission of the feed-in signal of the feeder cable. In the second embodiment, the radiation conductor 21, flexible substrate 22, flexible feeder cable 23, first flexible substrate 25 and first secondary conductor 26 jointly form a thin laminated antenna structure, which has improvements over the conventional hard multi-layer PCB (Printed Circuit Board) antenna structure.

Refer to FIG. 6 a perspective exploded view schematically showing a flexible printed circuit according to a third embodiment of the present invention. In the third embodiment, the flexible printed antenna comprises a radiation conductor 61, a first flexible substrate 62, a flexible feeder cable 63, a grounding member 64, a second flexible substrate 65 and a third flexible 66.

The third embodiment is basically similar to the first embodiment in that one end of the flexible feeder cable 63 is connected to a primary conductor 611 but different from the first embodiment in that an inductor unit 631 and a capacitor unit 632 are arranged in another end of the flexible feeder cable 63. The capacitor unit 632 is formed of a first coupling member 632a and a second coupling member 632b. In the present invention, the inductor unit 631 and the capacitor unit 632 may be connected in parallel or in series. In the third embodiment, the inductor unit 631 and the capacitor unit 632 are connected in parallel. Further, the inductor unit 631 is fabricated to have a serpentine form, and the first coupling member 632a and the second coupling member 632b of the capacitor unit 632 are arranged oppositely.

In assembling the antenna, a second secondary conductor 613 is arranged on a first surface 651 of the second flexible substrate 65, which is the top surface of the second flexible substrate 65. First sides of the primary conductor 611, the inductor unit 631 and the first coupling member 632a of the flexible feeder cable 63 are stuck on to the lower surface (not shown in the drawing) of the second flexible substrate 65. Second sides of the primary conductor 611 and the inductor unit 631 are stuck onto a second surface 661 of the third flexible substrate 66, which is the top surface of the third flexible 66. One terminal of the inductor unit 631 is connected to the flexible feeder cable 63. The other terminal of the inductor unit 631 extends serpentinely far away from the flexible feeder cable 63 toward one lateral of the third flexible substrate 66 and then reaches a second conduction hole 622, whereby the signal transmitted by the inductor unit 631 goes through the second conduction hole 622 to the first flexible substrate 62, the second flexible substrate 65 and the third flexible substrate 66. The serpentine inductor unit 631 has a better performance, and thus the inductive impedance of the antenna system is increased. The lower surface (not shown in the drawing) of the third flexible substrate 66 is arranged on a third surface 623, which is the top surface of the first flexible substrate 62. The third flexible substrate 66 contracts from the signal source toward the primary conductor 611 lest the third flexible substrate 66 cover the second coupling member 632b, which is stuck onto the first flexible substrate 62. Thus, the first coupling member 632a and the second coupling member 632b are located oppositely and have a gap therebetween to generate a capacitive coupling effect and enhance the performance of the capacitive coupling of the antenna. Thereby, the antenna has better capacitive impedance. Besides, the first secondary conductor 612 is arranged on the lower surface (not shown in the drawing) of the first flexible substrate 62.

In transmitting signals, the signal source feeds the positive signal of the antenna into the feeder cable 63. Next, the feed-in signal is transmitted to the second coupling member 632b, and then transmitted to the first coupling member 632a in a capacitive coupling way. Next, the signal is transmitted to the inductor unit 631 and then the primary conductor 611. Via the second conduction holes 622, the inductor unit 631 further transmits the signal to the first, second and third flexible substrates 62, 65 and 66. The negative signal of the antenna is transmitted to the grounding member 64 and then to the first secondary conductor 612 via through-holes 641. Further, the negative signal is transmitted to the second secondary conductor 613 via first conduction holes 621. Thereby is transceived the antenna signal.

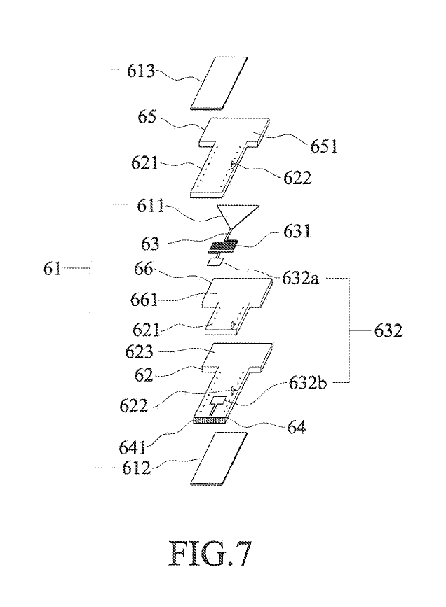

Refer to FIG. 7 a perspective exploded view schematically showing a flexible printed circuit according to a fourth embodiment of the present invention. The fourth embodiment is basically similar to the third embodiment except the inductor unit 631 is connected with the capacitor unit 632 in series. The signal transmission path in the fourth embodiment is similar to that in the third embodiment. In the fourth embodiment, the signal source feeds the positive signal of the antenna into the feeder cable 63. Next, the feed-in signal is transmitted to the second coupling member 632b, and then transmitted to the first coupling member 632a in a capacitive coupling way. Next, the signal is transmitted to the inductor unit 631 and then the primary conductor 611. Via the second conduction holes 622, the inductor unit 631 further transmits the signal to the first, second and third flexible substrates 62, 65 and 66. The negative signal of the antenna is transmitted to the grounding member 64 and then to the first secondary conductor 612 via through-holes 641. Further, the negative signal is transmitted to the second secondary conductor 613 via first conduction holes 621. Thereby is transceived the antenna signal.

The present invention possesses utility, novelty and non-obviousness and meets the condition for a patent. Thus, the Inventor files the application for a patent. The embodiments described above are only to exemplify the present invention but not to limit the scope of the present invention. Any equivalent modification or variation according to the spirit of the present invention is to be also included within the scope of the present invention.

What is claimed is:

1. A flexible printed antenna comprising
a flexible substrate;
a radiation conductor including a primary conductor and at least one secondary conductor, wherein said flexible substrate is interposed between said primary conductor and said secondary conductor;
a flexible feeder cable with one end thereof connected with said primary and another end thereof extending far away from said primary conductor; and
a grounding member arranged on said flexible substrate.

2. The flexible printed antenna according to claim 1, wherein said flexible substrate is a flexible printed circuit board.

3. The flexible printed antenna according to claim 1, wherein said grounding member has a plurality of through-holes electrically interconnecting said secondary conductor and said grounding member.

4. The flexible printed antenna according to claim 1, wherein said grounding member and said primary conductor are arranged on an identical surface of said flexible substrate.

5. The flexible printed antenna according to claim 1, wherein said secondary conductor and said flexible feeder cable jointly form a feeding-transmitting interface of high-frequency signals of said antenna.

6. The flexible printed antenna according to claim 1, wherein said primary conductor and said secondary conductor form a main structure of said radiation conductor.

7. A flexible printed antenna comprising
a flexible substrate;
a radiation conductor including a primary conductor and at least one secondary conductor, wherein said flexible substrate is interposed between said primary conductor and said secondary conductor;
a flexible feeder cable with one end thereof connected with said primary and another end thereof extending far away from said primary conductor to connect with a capacitor unit and an inductor unit, wherein said capacitor unit includes a first coupling member and a second coupling member, and wherein said first coupling member and said second coupling member are arranged oppositely at different surfaces of said flexible substrate; and
a grounding member arranged on said flexible substrate.

8. The flexible printed antenna according to claim 7, wherein said flexible substrate is a flexible printed circuit board.

9. The flexible printed antenna according to claim 7, wherein said grounding member has a plurality of through-holes electrically interconnecting said secondary conductor and said grounding member.

10. The flexible printed antenna according to claim 7, wherein said inductor unit, said capacitor unit, said primary conductor and said grounding member are arranged on an identical surface of said flexible substrate.

11. The flexible printed antenna according to claim 7, wherein said secondary conductor and said flexible feeder cable jointly form a feeding-transmitting interface of high-frequency signals of said antenna.

12. The flexible printed antenna according to claim 7, wherein said primary conductor and said secondary conductor form a main structure of said radiation conductor.

13. The flexible printed antenna according to claim 7, wherein said capacitor unit and said inductor unit are connected in parallel.

14. The flexible printed antenna according to claim 7, wherein said capacitor unit and said inductor unit are connected in series.
